(19) United States
(12) Patent Application Publication
(10) Pub. No.: US 2026/0105699 A1
(43) Pub. Date: Apr. 16, 2026

(54) METHODS AND SYSTEMS INCORPORATING SPATIALLY-DEFINED VIDEO-SEE-THROUGH MODIFICATIONS

(71) Applicant: Varjo Technologies Oy, Helsinki (FI)

(72) Inventors: Niki Dobrev, Helsinki (FI); Ville Timonen, Helsinki (FI)

(73) Assignee: Varjo Technologies Oy, Helsinki (FI)

(21) Appl. No.: 18/915,913

(22) Filed: Oct. 15, 2024

(51) Int. Cl. G06T 19/00; G06T 3/40; G06T 5/70; G06T 5/73; G06T 5/80

(52) U.S. Cl. CPC G06T 19/006; G06T 3/40; G06T 5/70; G06T 5/73; G06T 5/80

(57) ABSTRACT

A method incorporating spatially-defined video-see-through (VST) modifications. includes receiving VST images (300a-c) of a real-world environment captured using at least one VST camera (208a-b) and depth data corresponding to the VST images; receiving a pose of at least one object present in the environment; analysing the VST images, depth data, and pose of the object(s), for identifying in a given VST image, change(s) in at least one spatial volume surrounding the object(s); determining a range of optical depth values for each pixel of the given VST image, by projecting the spatial volume(s) onto image coordinates; determining whether an optical depth value of a pixel of the given VST image lies within the range of optical depth values determined for the pixel; and applying image processing operation(s) on the pixel, when said determination is true.

### TECHNICAL FIELD

The present disclosure relates to methods incorporating spatially-defined video-see-through modifications. The present disclosure also relates to systems incorporating spatially-defined video-see-through modifications.

### BACKGROUND

Nowadays, there is an increased demand for extended reality (XR) devices across various fields, for example, such as entertainment, real estate, training, medical imaging operations, simulators, navigation, and the like. Such XR devices typically involve head-mounted displays (HMDs) which are designed to offer immersive visual experiences. However, existing image processing technology used in such XR devices has certain problems associated therewith.

The existing image processing technology is prone to inaccurately apply any virtual modification in a live video feed of a real-world environment, based on real world spatial regions. This is because the existing image processing technology involves applying a virtual modification in VST images everywhere at once or in certain parts based on 2D image coordinates without real world spatial awareness. This also results in significant consumption of computational resources and extensive time spent in post processing of the VST images. Secondly, some existing image processing technology fails to ensure whether application of any virtual modification is affecting an appearance of an object that is either in a front of or behind a target region where the virtual modification is being applied. Thirdly, the existing image processing technology fails to adequately support real-time changes needed in a virtual environment, without altering a physical space, hence limiting a flexibility and realism for users using XR devices.

Therefore, in light of the foregoing discussion, there exists a need to overcome the aforementioned drawbacks.

### SUMMARY

The aim of the present disclosure is to provide a method and a system to apply image processing operations on pixels of VST images in a highly accurate and realistic manner by defining spatial volumes surrounding objects in a computationally and time-efficient manner. The aim of the disclosure is achieved by a method and a system which incorporate spatially-defined video-see-through modifications as defined in the appended independent claims. The embodiments of the present disclosure substantially enable to improve the accuracy and realism of virtual modifications applied within mixed reality environments. Additional aspects, advantages, features, and objects of the present disclosure will become apparent from the drawings and the detailed description of the illustrative embodiments constructed in conjunction with the appended claims that follow.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates steps of a method incorporating spatially-defined video-see-through (VST) modifications, in accordance with an embodiment of the present disclosure;

FIG. 2 illustrates a block diagram of architecture of a system incorporating spatially-defined video-see-through (VST) modifications, in accordance with an embodiment of the present disclosure;

FIGS. 3A, 3B, and 3C illustrate different exemplary scenarios of applying image processing operations in video-see-through (VST) images, in accordance with an embodiment of the present disclosure; and

FIGS. 4A, 4B, 4C, 4D, and 4E illustrate different example implementations of tracking means, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a method incorporating spatially-defined video-see-through (VST) modifications, wherein the method comprises:
receiving a plurality of VST images of a real-world environment captured using at least one VST camera and depth data captured corresponding to the plurality of VST images, the depth data comprising optical depth values of pixels of each of the plurality of VST images;
receiving a pose of at least one object present in the real-world environment;
analysing the plurality of VST images, the depth data, and the pose of the at least one object, for identifying, in a given VST image, at least one change in at least one spatial volume surrounding the at least one object;
determining a range of optical depth values for each pixel of the given VST image, by projecting the at least one spatial volume onto image coordinates of the given VST image;
determining whether an optical depth value of a given pixel of the given VST image lies within the range of optical depth values determined for said pixel of the given VST image; and
applying at least one image processing operation on the given pixel of the VST image, when it is determined that the optical depth value of the given pixel of the given VST image lies within the range of optical depth values.

In a second aspect, an embodiment of the present disclosure provides a system incorporating spatially-defined video-see-through (VST) modifications, wherein the system comprises:
a display apparatus comprising at least one VST camera per eye, the at least one VST camera facing a real-world environment where a user of the display apparatus is present;
at least one tracking means arranged on at least one object present in the real-world environment; and at least one processor configured to:
receive a plurality of VST images of a real-world environment captured using the at least one VST camera and depth data captured corresponding to the plurality of VST images, the depth data comprising optical depth values of pixels of each of the plurality of VST images;
obtain a pose of the at least one object present in the real-world environment, by processing pose-tracking data that is collected by the at least one tracking means;
analyse the plurality of VST images, the depth data, and the pose of the at least one object, for identifying, in a given VST image, at least one change in at least one spatial volume surrounding the at least one object;
determine a range of optical depth values for each pixel of the given VST image, by projecting the at least one spatial volume onto image coordinates of the given VST image;
determine whether an optical depth value of a given pixel of the given VST image lies within the range of optical depth values determined for said pixel of the given VST image; and
apply at least one image processing operation on the given pixel of the VST image, when it is determined that the optical depth value of the given pixel of the given VST image lies within the range of optical depth values.

The present disclosure provides the aforementioned method and the aforementioned system which incorporates spatially-defined video-see-through (VST) modifications. The method and the system enables modifying the VST images in an accurate and precise manner by using the at least one spatial volume. By analysing and utilizing the depth data and the pose information of the at least one object within the real-world environment, the method and the system facilitates in ensuring that virtual modifications are applied with precise spatial awareness, for example, by taking into account at least a partial occlusion of object being captured in a real-world environment where a user is present. This enhances a realism and an immersiveness for a user within an MR environment. Moreover, by determining that the optical depth value of the given pixel of the given VST image lies within the range of optical depth values, the method and the system enables in ensuring that the at least one image processing operation is applied correctly where it is intended, even when the at least one object gets occluded. This results in saving computational resources and processing time, whilst ensuring that the VST modifications are highly relevant and contextually appropriate. The method and the system are susceptible to providing real-time post-processing changes required in presenting a virtual environment, without altering a physical space. The method and the system are simple, robust, fast, reliable, support real time or near-real time VST modifications, and can be implemented with ease.

The VST image is a visual representation of the real-world environment. The term “visual representation” encompasses colour information represented in the VST image, and additionally optionally other attributes (for example, such as depth information, transparency information, luminance information, brightness information, and the like) associated with the VST image.

Optionally, depth data corresponding to a given VST image is in a form of a depth image. Herein, the term “depth image” refers to an image that is indicative of optical depths of objects or their portions present in the real-world environment. Optionally, the depth image is in a form of a depth map. The term “depth map” refers to a data structure comprising information pertaining to the optical depths of the objects or their portions present in the real-world environment. The depth map could be an image comprising a plurality of pixels, wherein a pixel value of each pixel indicates an optical depth of its corresponding 3D point within a region of the real-world environment. Optionally, the depth data is captured using at least one depth camera. Alternatively, optionally, the depth data is captured using a pair of VST cameras. In such a case, the depth data is generated, based on a stereo disparity between a stereo pair of VST images captured using the pair of VST cameras. It will be appreciated that the at least one VST camera is arranged on the display apparatus in such a way that it aligns with the user's eyes, thereby ensuring that the given VST image would correspond to a field of view of a user of the display apparatus. It is to be understood that a given optical depth value is a numerical representation of a distance between the at least one VST camera and a corresponding 3D point in the real-world environment, for a given pixel of the given VST image.

Optionally, the at least one VST camera is implemented as a visible-light camera. Examples of the visible-light camera include, but are not limited to, a Red-Green-Blue (RGB) camera, a Red-Green-Blue-Alpha (RGB-A) camera, a Red-Green-Blue-Depth (RGB-D) camera, an event camera, a Red-Green-Blue-White (RGBW) camera, a Red-Yellow-Yellow-Blue (RYYB) camera, a Red-Green-Green-Blue (RGGB) camera, a Red-Clear-Clear-Blue (RCCB) camera, a Red-Green-Blue-Infrared (RGB-IR) camera, and a monochrome camera. Additionally, optionally, the at least one VST camera is implemented as a depth camera. Examples of the depth camera include, but are not limited to, a Time-of-Flight (ToF) camera, a light detection and ranging (LiDAR) camera, a Red-Green-Blue-Depth (RGB-D) camera, a laser rangefinder, a stereo camera, a plenoptic camera, an infrared (IR) camera, a ranging camera, a Sound Navigation and Ranging (SONAR) camera. Optionally, the at least one VST camera is implemented as a combination of the visible-light camera and the depth camera.

Throughout the present disclosure, the term “display apparatus” refers to a specialised equipment that is capable of at least displaying images. Optionally, the display apparatus is implemented as a head-mounted display (HMD) device. The term “head-mounted display device” refers to specialised equipment that is configured to present a mixed-reality (MR) environment to the user when said HMD device, in operation, is worn by the user on his/her head. The HMD device is implemented, for example, as an MR headset, a pair of MR glasses, and the like, that is operable to display a visual scene of the MR environment to the user.

Notably, the at least one processor controls an overall operation of the system. The at least one processor is communicably coupled to at least the display apparatus and the at least one tracking means. Optionally, the at least one processor is implemented as a processor of a computing device. Examples of the computing device include, but are not limited to, a laptop, a desktop, a tablet, a phablet, and a console. Alternatively, optionally, the at least one processor is implemented as a cloud server (namely, a remote server) that provides a cloud computing service.

The term “pose” encompasses a viewing position and/or a viewing orientation of the at least one object present in the real-world environment. When the display apparatus is in operation, the at least one object is continuously tracked (for example, using at least one tracking means, as discussed hereinbelow) for determining the pose of the at least one object. Optionally, the method further comprises processing pose-tracking data, collected by at least one tracking means, to determine the pose of the at least one object, wherein the at least one tracking means is arranged on the at least one object. Herein, the term “tracking means” refers to specialised equipment that is employed to detect and/or follow the pose of the at least one object. Optionally, the at least one tracking means could be at least one of: an optics-based tracking system (which utilizes, for example, infrared beacons and detectors, infrared cameras, visible-light cameras, and the like), an acoustics-based tracking system, a radio-based tracking system, a magnetism-based tracking system, an accelerometer, a gyroscope, an Inertial Measurement Unit (IMU), a Timing and Inertial Measurement Unit (TIMU). All the aforesaid types of tracking means are well-known in the art. Optionally, the at least one processor is configured to employ at least one data processing algorithm to process the pose-tracking data, to determine the pose of the at least one object. The pose-tracking data may be in the form of images, IMU/TIMU values, motion sensor data values, magnetic field strength values, or similar. Examples of the at least one data processing algorithm include, but are not limited to, a feature detection algorithm, an environment mapping algorithm, and a data extrapolation algorithm. It will be appreciated that the at least one tracking means continuously tracks the pose of the at least one object throughout a given session of using the system (or the display apparatus). In such a case, the at least one processor repeatedly determines the pose of the at least one object, in real-time or near-real time. Techniques for tracking objects using tracking means are well-known in the art.

It will be appreciated that when the at least one object comprises a plurality of object, it may not be necessary that the at least one tracking means would be arranged on each object from amongst the plurality of objects. This is because there could be some objects from amongst the plurality of objects which are static in the real-world environment, and tracking their poses may not be necessary (as their poses do not change with respect to time). In such a case, the at least one tracking means may not be arranged on such objects, and their poses in the real-world environment could be pre-known to the at least one processor. The technical benefit of determining the pose using the at least one tracking means is that said pose is determined in a highly accurate, reliable manner, which subsequently facilitates in identifying the at least one change in the at least one spatial volume surrounding the at least one object. This is because the at least one spatial volume may change with a change in the pose of the at least one object.

Optionally, the at least one object is at least one of: an interaction device associated with a display apparatus, a body part of a user of the display apparatus, at least one another display apparatus, an interaction device associated with the at least one another display apparatus, a body part of a user of the at least one another display apparatus, a person, an animal, a moving object, a static object.

Herein, the term “interaction device” refers to a device that is used by a user in conjunction with a display apparatus, in order to interact with virtual elements of an MR environment. The at least one interaction device could be, for example, such as a handheld controller, a gesture recognition device, an audio device, a microphone, or similar. Further, the body part of the user could, for example, be a hand, a wrist, an arm, a head, a waist, a leg, or the like. It will be appreciated that in a multi-user scenario, the user of the at least one another display apparatus is present in a same real-world environment where the user of the display apparatus is also present. In such a case, the at least one another display apparatus is considered to be an object that is to be tracked using the at least one tracking means. This is because when the HMD device is in use by the user of the display apparatus, a field of view of the user of the display apparatus (and thus, a corresponding VST image) may comprise the at least one another display apparatus. Due to similar reasons, tracking of at least one of: the interaction device associated with the at least one another display apparatus, the body part of the user of the at least one another display apparatus, is also performed in a same manner. The moving object could, for example, be a vehicle, a drone, a robot, a moving mechanical tool, or similar. The static object could, for example, be a table, a chair, a painting, a lamp, a plant, or similar.

Optionally, the at least one tracking means is implemented as any one of: a self-tracking means having a camera thread interface, a fixed-mount tracking means, a strap-mount tracking means, a handle-mount tracking means.

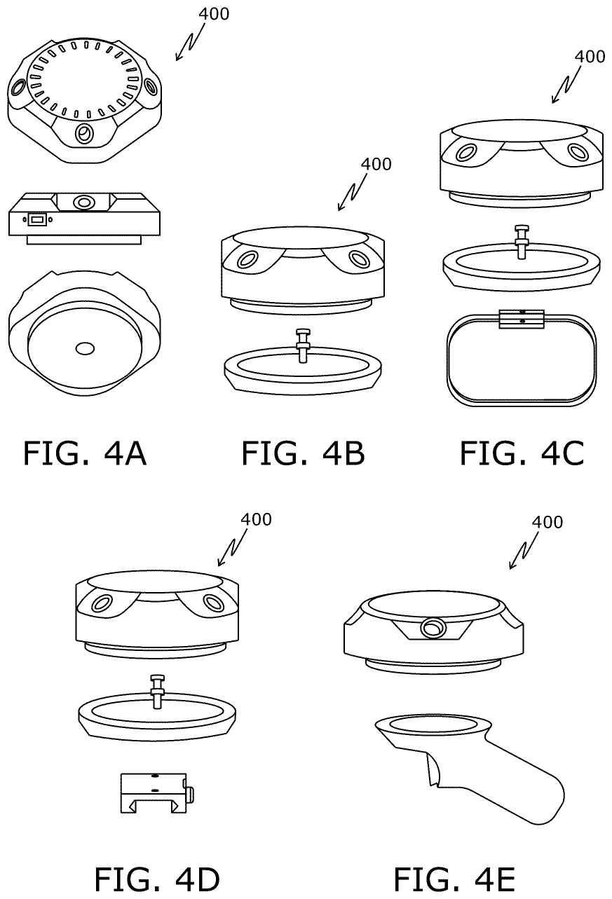

In this regard, the camera thread interface in the self-tracking means facilitates in providing a standardised attachment point which allows the self-tracking means to be easily mounted onto a camera. There could be different shapes of the self-tracking means, for example, such as a circular shape, a rectangular shape, a disc-like shape, or similar. Furthermore, the self-tracking means can be suitable for tracking the interaction device and/or the body part of the user (for example, a head of the user). Further, the fixed mounted tracking means is typically arranged in a stable location where it continuously tracks/monitors poses of objects that are present within its field of view. In this regard, the fixed mount tracking means can be suitable for tracking the static object. Moreover, the strap-mount tracking means is used when there is a need to attach the at least one tracking means to the at least one object that requires a secure and flexible mounting. The strap-mount tracking means provides versatility and stability for accurately collecting the pose-tracking data, even in dynamic real-world environments. It will be appreciated that the strap-mount tracking means may comprises an adjustable buckle that is used to easily tighten or loosen its fit with the at least one object, thereby ensuring a secure attachment of the strap-mount tracking means with the at least one object. In this regard, the strap-mount tracking means could be suitable for tracking in the body part of the user of the another display apparatus. Furthermore, the handle-mount tracking means is designed to be attached to a handle or a similar structure, providing a secure and stable way to track movements or positions of the at least one object. This type of tracking means is particularly useful for tracking the interaction device. The handle-mount tracking means ensures that the tracking mechanism is firmly attached to the handle, allowing for accurate pose-tracking data collection even when the at least one object is in motion. Optionally, the at least one tracking means is implemented as a standardised rail-mount tracking means (for example, a NATO rail-mount tracking means). The aforesaid implementations of the at least one tracking means are illustrated in conjunctions with FIGS. 4A-4E.

Throughout the present disclosure, the term “spatial volume” refers to a three-dimensional (3D) volume in the real-world environment that surrounds the at least one object. The at least one spatial volumes can, for example, encompass persons or target objects within a training environment. For a given VST image, a single 3D point in the real-world environment corresponds to a single pixel in the given VST image. It will be appreciated that a shape of the at least one spatial volume may conform to a shape of the at least one object. In some implementations, the at least one spatial volume surrounds (and optionally, includes) a static object present in the real-world environment. In other implementations, the at least one spatial volume surrounds (and optionally, includes) a moving object present in the real-world environment. It is to be noted that the phrase “at least one spatial volume surrounding the at least one object” does not necessarily mean that the at least one spatial volume is in a direct contact with the at least one object. As an example, a spatial volume corresponding to a given object can be, for example, 0.5 meters away from a position of the given object, but still surrounding the given object.

Notably, the plurality of VST images, the depth data, and the pose of the at least one object are analysed to identify any change in the at least one spatial volume surrounding the at least one object. This is performed because the at least one spatial volume may change due to a movement or a repositioning of the at least one object (for example, when the at least one object is a dynamic object), which may directly impact an accuracy of the at least one image processing operation that would be applied on the given pixel of the VST image. Thus, identifying such a change in the at least one spatial volume would ensure that a given image processing operation is correctly applied on the given pixel.

It will be appreciated that for the given VST image, when identifying the at least one change, the at least one spatial volume is projected onto image coordinates of the given VST image. Such a projection means that the at least one (3D) spatial volume is translated into two-dimensional (2D) image coordinates corresponding to the given VST image, thereby allowing the at least one processor to map out which areas of the given VST image correspond to the at least one spatial volume surrounding the at least one object. Then, the at least one processor compares the at least one projected spatial volume with at least one previously-projected spatial volume, based on the pose of the at least one object. Such a comparison allows for determining the at least one change in the at least one spatial volume surrounding the at least one object. Said comparison may be done in a pixel-by-pixel manner. If any change is detected, for example, such as a shift in boundaries of the at least one spatial volume, indicating that the at least one object has moved or that another object has entered the at least one spatial volume, the at least one processor identifies this as the at least one change in the at least one spatial volume. It will also be appreciated that the depth data and the pose are utilised in tandem to refine the aforesaid analysis. Since the pose provides information pertaining to where the at least one object is and how it is oriented, and the depth data provides optical depths from the display apparatus to the at least one object. By cross-referencing these data points, the at least one processor can more accurately determine if a change in the at least one spatial volume has occurred, such as the at least one object moving closer or further from the display apparatus, rotating, or if another object has moved into the at least one spatial volume (namely, if another object has partially or fully occluded the at least one object).

Optionally, the at least one change in the at least one spatial volume is at least one of:
(i) a change in at least one of: a position, an orientation, a geometry, a state, of the at least one object,
(ii) at least a partial occlusion of the at least one object.

In this regard, the at least one processor identifies the change in the at least one spatial volume, when there would be a change in the position of the at least one object. For example, an initial position and a final position of the at least one object may be determined using the pose-tracking data. When it is determined that the initial position and the final position of the at least one object are same, the at least one processor detects no change in the at least one spatial volume. On the other hand, when it is determined that the initial position and the final position of the at least one object are different, the at least one processor detects a change in the at least one spatial volume. In an example, in an MR training simulation, when a user moves his/her hand from one position to another position, the at least one processor may identify a change in at least one spatial volume surrounding the user's hand. Further, the change in the orientation of the at least one object means the at least one object has rotated or tilted in some direction. When the at least one processor detects the change in the geometry of the at least one object, it may involve analysing changes in a geometric structure of the at least one object within the at least one spatial volume. Furthermore, when the at least one processor detects the change in the state of the at least one object (namely, a change in a condition of the at least one object), it may involve monitoring specific state changes, for example, such as on/off, open/closed, or color changes. When the at least one change is at least the partial occlusion of the at least one object, it means that the at least one object becomes at least partially hidden from a perspective of a pose with which the VST image has been captured, due to presence of another object or any other environmental factor obstructing the at least one object.

Optionally, the step of analysing the plurality of VST images, the depth data, and the pose of the at least one object comprises:
identifying positions of features of a given object represented in a given VST image; and
refining the positions of the features of the given object by utilising at least one object segmentation technique and the depth data together.

In this regard, the features could, for example, be edges, corners, lines, ridges, blobs, low-frequency features, high-frequency features, and the like. Optionally, the at least one processor is configured to employ at least one data processing algorithm for extracting the features of the given object represented in the given VST image. Examples of the at least one data processing algorithm include, but are not limited to, an edge-detection algorithm (for example, such as Canny edge detector, Deriche edge detector and the like), a corner-detection algorithm (for example, such as Harris & Stephens corner detector, Shi-Tomasi corner detector, Features from Accelerated Segment Test (FAST) corner detector and the like), a blob-detection algorithm (for example, such as Laplacian of Gaussian (LoG)-based blob detector, Difference of Gaussians (DoG)-based blob detector, Maximally Stable Extremal Regions (MSER) blob detector, and the like), a feature descriptor algorithm (for example, such as Binary Robust Independent Elementary Features (BRIEF), Gradient Location and Orientation Histogram (GLOH), Histogram of Oriented Gradients (HOG), and the like), a feature detector algorithm (for example, such as the SIFT, the SURF, Oriented FAST and rotated BRIEF (ORB), and the like). Once the features are extracted, the positions of the features in the given VST image could be easily and accurately identified, for example, using image coordinates of pixels of the given VST image.

It will be appreciated that the positions of the features of the given object are refined by using the at least one object segmentation technique and the depth data, to enhance an accuracy of feature localisation. This may be because the at least one object segmentation technique isolates the given object from its surroundings within the VST image, thereby distinguishing boundaries and key features of the given image. Simultaneously, the depth data provides information pertaining to an optical depth of each feature relative to the display apparatus, adding a spatial dimension to the positions of the features. Beneficially, due to this, the at least one processor could adjust initial positions of the features to account for any discrepancies, for example, such as those caused due to background noise in the VST image or overlapping objects represented in the VST image.

It will also be appreciated that performing the identification of the positions of the features and refining them in the aforesaid manner provides technical benefits in context of identifying the at least one change in the at least one spatial volume surrounding the given object. By accurately determining the positions of features, the at least one processor can precisely define the at least one spatial volume associated with the at least one object. This accuracy is crucial for detecting any changes within the at least one spatial volume, such as shifts in the object's position, orientation, or its state. When the features of the object are precisely localised, any subsequent analysis to detect changes in the at least one spatial volume becomes reliable. For example, when an object's position changes slightly, the refined feature positions enable the at least one processor to detect a subtle movement, which might otherwise go unnoticed if the feature's positions were not accurately determined. Additionally, refining these positions may help in distinguishing real changes from artifacts or noise in the VST image, reducing a likelihood of false positives. This enhances an ability of the system to identify actual changes in the at least one spatial volume, improving an overall accuracy and reliability in performing spatially-defined video-see-through modifications.

Optionally, a size of the at least one spatial volume is predefined, and the size of the at least one spatial volume depends on at least one of: a type of the at least one object, a size of the at least one object, an extent of a tracking of the at least one object. In this regard, the size of the at least one spatial volume is determined based on predefined criteria that would take into account the aforesaid characteristics (i.e., the type, the size, and the extent of the tracking) of the at least one object. For example, when the at least one object is small in size, for example, such as a handheld controller, the at least one spatial volume surrounding such a small-sized object may be relatively compact, to accurately adapt according to physical dimensions of the small-sized object. On the other hand, when the at least one object is a larger, stationary piece of furniture, the spatial volume could be broader to encompass its larger physical dimensions and a range of tracking required to monitor it effectively. By defining the size of the at least one spatial volume in this manner, the system can ensure that the at least one spatial volume is appropriately tailored to prominent attributes of the at least one object, thereby enhancing an accuracy and reliability of object tracking and subsequent image processing tasks related to changes in the at least one spatial volume. It will be appreciated that by tailoring the at least one spatial volume to the specific characteristics of the at least one object, it may be ensured that the at least one spatial volume precisely reflects the object's dimensions and tracking requirements. Such a customisation minimizes a risk of including extraneous data or missing critical changes, leading to more reliable detection of alterations in the object's spatial environment. Consequently, this enhances an overall effectiveness of monitoring and analyzing the at least one object.

Alternatively, optionally, a size of the at least one spatial volume is user-configurable. It will be appreciated that when the display apparatus is in use, the user can modify (namely, increase or decrease) any dimension of the at least one spatial volume, according to his/her specific needs or preferences. Beneficially, such a flexibility in the MR environment allows the user to accommodate various use cases, object types, and interaction requirements. It will be appreciated that the user could provide an input pertaining to modification of a dimension of the at least one spatial volume using an input device (for example, an interaction device). Moreover, there could be one or more predefined options available to the user, based on a type of the at least one object, and such options could be displayed to the user via the display apparatus for selection purposes. The one or more predefined options could be such as small, large, medium, or specific object-based such as the body part of the user, the static object, the moving object, the interaction device, or similar. Optionally, a settings menu is displayed to the user via an interactive user interface, wherein the settings menu comprises features like dimension, aspect ratio, snapping to grid, custom shapes, or similar.

Notably, the range of the optical depth values for each pixel of the given VST image is determined by projecting the at least one spatial volume onto the image coordinates of the given VST image. This process may involve mapping a 3D spatial volume surrounding the at least one object onto a 2D plane of the VST image. In other words, the at least one spatial volume, which encompasses the object's physical space, is converted into corresponding image coordinates based on depth information. Optionally, the step of projecting the at least one spatial volume onto the image coordinates of the given VST image involves using a transformation matrix. Each pixel in the VST image then corresponds to a specific point in the at least one projected spatial volume. The optical depth values for these points are calculated, representing the distances from the display apparatus to various parts of the object within the at least one spatial volume. It will be appreciated the range of the optical depth values for each pixel may be defined, for example, by considering a minimum depth value and a maximum depth value that a given pixel could represent within the at least one spatial volume. Such a range allows for variations in depth values due to the object's dimensions and its distance from the display apparatus. Said range is subsequently used to perform depth testing during a rendering process to determine which pixels'optical depths fall within the specified range.

Once the range of the optical depth values is known, the at least one processor determines when the optical depth value of the given pixel of the given VST image lies within said range, and applies the at least one image processing operation on the given pixel of the VST image. This is because when the optical depth value of the given pixel lies within said range, it means that the given pixel would be visible to the user of the display apparatus (i.e., the given pixel is not occluded); thus, applying the at least one image processing operation on the given pixel would be beneficial, and no image processing operation would be applied to those pixels of the VST image that correspond to optical depths of objects that are in front of or behind the at least one object. On the other hand, when the optical depth value of the given pixel lies outside said range, it means that the given pixel would not be visible to the user of the display apparatus (i.e., the given pixel is occluded); thus, applying the at least one image processing operation on the given pixel would not be beneficial, and would be skipped. Thus, by checking if the given pixel's optical depth value lies within said range, the at least one processor selectively applies the at least one image processing operation, ensuring that only the relevant portions of the given VST image (which are actually visible to the user) are modified. Beneficially, such an approach helps to avoid incorrect VST modifications, such as altering pixels that should remain unchanged, thereby enhancing an accuracy and realism within an MR environment.

Optionally, the at least one image processing operation is at least one of: an image colour-change operation, an image lighting-change operation, an image resizing operation, an image rotating operation, an object removal operation, an object occlusion operation, a virtual object generation operation, a geometrical distortion operation, an image blurring operation, an image sharpening operation, a night vision simulation operation, a denoising operation, a noise addition operation.

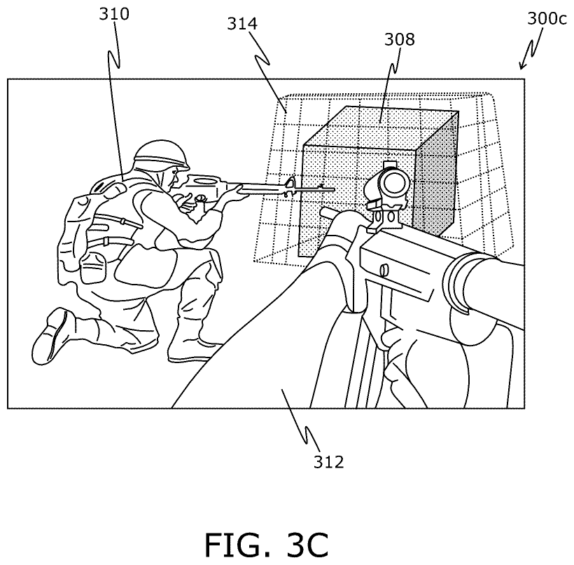

All the aforementioned image processing operations are well-known in the art. It is to be understood that which image processing operation is to be applied depends on a case-to-case basis or on a type of a mixed-reality (MR) environment that is to be presented to the user via the display apparatus. Such image processing operations are generally applied as post processing operations i.e., after a given VST image has been captured and is to be further processed to generate, for example, a corresponding MR image that could be presented to a user. In an example, in an MR training simulation, the image colour-change operation may be applied to change a colour of a target opponent in order to easily distinguish the target opponent amongst other objects in the MR environment. For example, the target opponent's colour may be changed to a red colour. In another example, a lighting of a virtual room may be increased or decreased to virtually make it a bright room or a dark room, without changing a larger physical space's lighting. The virtual room is a virtual representation of at least a portion of a room in the real-world environment. Moreover, the geometry of a given object can also be resized such as making the given object larger or shorter in size. Moreover, the given object can also be rotated around a specific axis. The image rotating operation can be used to provide different perspectives of the at least one object to the user. Moreover, the at least one object such as a person can be made to disappear from the MR environment during simulation, by masking it out by overlaying (namely, superimposing) a virtual object on top of it. In this regard, the object occlusion operation may be applied to the given pixel ensures that the virtual object correctly obscure any real-world object, based on depth information. The virtual object generation operation adds the virtual object into the given VST image. Furthermore, the geometrical distortion operation may be applied to distort a given object in the given VST image, for example, to simulate a shattered virtual glass. The image blurring operation may be applied to blur the at least one object, for example, blurring like people's faces in a live video feed of the real-world environment. The image sharpening operation may be applied to enhance appearance of edges and intricate visual details of a given object in the VST image, making the given object to appear clear. The night vision simulation operation is applied to create an effect of a night vision in the MR environment (for example, in a pilot training), for example, using virtual binoculars. Moreover, the noise can be added to the given VST image, which can be used to simulate various conditions such as poor visibility. Furthermore, the denoising operation reduces a noise from at least a part of the given VST image, resulting in a clean and smooth image. It improves the visual quality, especially in low-light conditions or in noisy conditions. How some of the image processing operations are applied to the given VST image, has been illustrated in conjunction with FIGS. 3A-3C, for sake of better understanding.

Optionally, the method further comprises applying the at least one image processing operation, based on a predefined criterion in a mixed-reality (MR) environment to be presented to a user via a display apparatus.

In this regard, the predefined criterion for applying the at least one image-processing operation may define a condition of when and how the at least one image processing operation is to be applied to the given pixel. In an example, the predefined criterion may be based on a user interaction, an environmental condition, a specific event, a temporal factor, or similar. Furthermore, when the predefined criterion is met, the at least one processor applies the at least one image processing operation to the given pixel. The technical benefit of this is that it improves a user experience within the MR environment by applying specific image processing operation(s) based on the predefined criterion. Such image processing operations are conditional, ensuring that modifications occur only when certain relevant conditions are satisfied, thereby creating an interactive and contextually-aware MR experience. Finally, MR images are presented to the user via the display apparatus, providing an immersive and responsive visual experience. In an example, the predefined criterion may be such that when time is running out in an MR game or in an MR simulation environment, a colour of a given object (for example, such a hostage or a mission target) is changed to a pulsing green colour.

The present disclosure also relates to the system as described above. Various embodiments and variants disclosed above, with respect to the aforementioned method, apply mutatis mutandis to the system.

Optionally, in the system, the at least one image processing operation is at least one of: an image colour-change operation, an image lighting-change operation, an image resizing operation, an image rotating operation, an object removal operation, an object occlusion operation, a virtual object generation operation, a geometrical distortion operation, an image blurring operation, an image sharpening operation, a night vision simulation operation, a denoising operation, a noise addition operation. Optionally, in the system, the at least one object is at least one of: an interaction device associated with a display apparatus, a body part of a user of the display apparatus, at least one another display apparatus, an interaction device associated with the at least one another display apparatus, a body part of a user of the at least one another display apparatus, a person, an animal, a moving object, a static object.

Optionally, in the system, the at least one change in the at least one spatial volume is at least one of:
(i) a change in at least one of: a position, an orientation, a geometry, a state, of the at least one object,
(ii) at least a partial occlusion of the at least one object.

Optionally, in the system, a size of the at least one spatial volume is predefined, and the size of the at least one spatial volume depends on at least one of: a type of the at least one object, a size of the at least one object, an extent of a tracking of the at least one object.

### DETAILED DESCRIPTION OF THE DRAWINGS

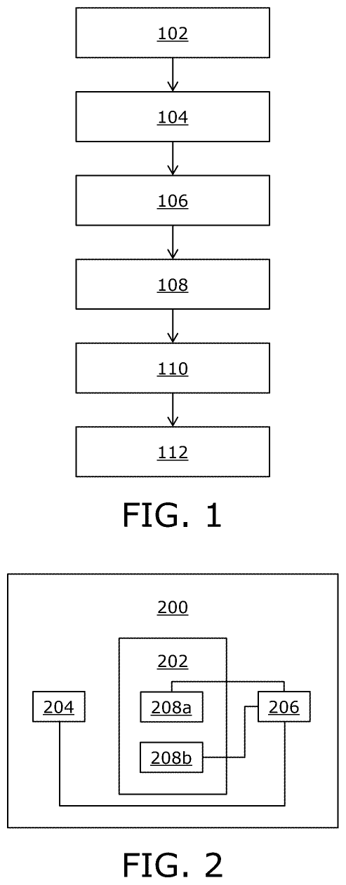

Referring to FIG. 1, illustrated are steps of a method for incorporating spatially-defined video-see-through (VST) modifications, in accordance with an embodiment of the present disclosure. At step 102, a plurality of VST images of a real-world environment that are captured using at least one VST camera, and depth data that is captured corresponding to the plurality of VST images, is received, wherein the depth data comprises optical depth values of pixels of each of the plurality of VST images. At step 104, a pose of at least one object present in the real-world environment, is received. At step 106, the plurality of VST images, the depth data, and the pose of the at least one object are analysed for identifying, in a given VST image, at least one change in at least one spatial volume surrounding the at least one object. At step 108, a range of optical depth values for each pixel of the given VST image is determined, by projecting the at least one spatial volume onto image coordinates of the given VST image. At step 110, it is determined whether an optical depth value of a given pixel of the given VST image lies within the range of optical depth values determined for said pixel of the given VST image. When it is determined that the optical depth value of the given pixel of the given VST image lies within the range of optical depth values, at step 112, at least one image processing operation on the given pixel of the VST image is applied.

The aforementioned steps are only illustrative and other alternatives can also be provided where one or more steps are added, one or more steps are removed, or one or more steps are provided in a different sequence without departing from the scope of the claims.

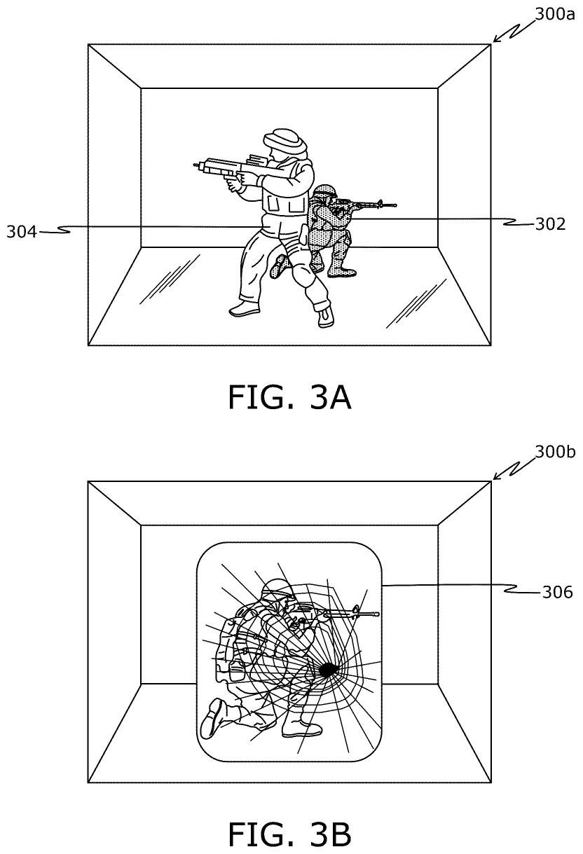

Referring to FIG. 2, illustrated is a block diagram of architecture of a system incorporating spatially-defined video-see-through (VST) modifications, in accordance with an embodiment of the present disclosure. The system 200 comprises a display apparatus 202, at least one tracking means (for example, depicted as tracking means 204), and at least one processor (for example, depicted as a processor 206). The display apparatus 202 comprises at least one VST camera per eye (for example, depicted as VST cameras 208a and 208b for a first eye and a second eye, respectively). The processor 206 is communicably coupled to the display apparatus 202 and the tracking means 204, and optionally, to the VST cameras 208a and 208b. The processor 206 is configured to perform various operations, as described earlier with respect to the aforementioned second aspect.

It may be understood by a person skilled in the art that FIG. 2 includes a simplified architecture of the system 200, for sake of clarity, which should not unduly limit the scope of the claims herein. It is to be understood that the specific implementation of the system 200 is provided as an example and is not to be construed as limiting it to specific numbers or types of display apparatuses, tracking means, processors, and VST cameras. The person skilled in the art will recognize many variations, alternatives, and modifications of embodiments of the present disclosure.

Referring to FIGS. 3A, 3B, and 3C, illustrated are different exemplary scenarios of applying image processing operations in video-see-through (VST) images 300a, 300b, and 300c, in accordance with an embodiment of the present disclosure. With reference to FIGS. 3A, 3B, and 3C, there is shown a collaborative mixed-reality (MR) training environment in which a plurality of users are present. The VST images 300a-c are captured by a VST camera (not shown) arranged on a head-mounted display (HMD) device (not shown) being worn by a user (not shown) on his/her head. Upon applying the image processing operation in the VST images 300a-c, at least one processor (not shown) is optionally configured to generate corresponding mixed-reality (MR) images by utilising the VST images 300a-c.

With reference to FIG. 3A, an image colour-change operation is applied to pixels of the VST image 300a, wherein said pixels represent a target object 302 (for example, shown as a friendly solider) in the VST image 300a, by taking into account a partial occlusion of the target object 302 by another object 304. It is to be noted that the image colour-change operation has been applied to pixels belonging to the target object 302 only, and not to any other pixels belonging to the another object 304. In an example, a colour of the target object 302 may be changed to a red colour (depicted using a dotted pattern, only for sake of simplicity and convenience). Applying the image colour-change operation facilitates in highlighting the target object 302 in the VST image 300a. This enables the user of the display apparatus to easily visually distinguish the target object 302, when a corresponding MR image is presented to the user via the display apparatus.

With reference to FIG. 3B, a geometrical distortion operation is applied to pixels of the VST image 300b, wherein said pixels represent an object 306 (for example, shown as a virtual riot shield) in the VST image 300b. Applying the geometrical distortion operation facilitates in simulating a fractured glass of the virtual riot shield (namely, the object 306). This enables the user of the display apparatus to experience realism and immersive within the collaborative MR training environment, when a corresponding MR image is presented to the user via the display apparatus.

With reference to FIG. 3C, a virtual object generation operation is applied to the VST image 300c, by taking into account a partial occlusion of the an object 308 (for example, a hostage target) by another objects 310 and 312 (depicted as two soldiers and their at least one body part and weapons), wherein a virtual object 314 (depicted as a dotted-line cage) is shown to be generated in a manner that the virtual object 314 (transparently) encloses the object 308. Moreover, colours of the objects 308 and 314 are changed (by applying an image colour-change operation) in a pulsating manner when a time period is running out, to simulate a hostage being captured within the collaborative MR training environment. This enables the user of the display apparatus to experience realism and immersive within the collaborative MR training environment, when a corresponding MR image is presented to the user via the display apparatus.

FIGS. 3A-3C are merely examples, which should not unduly limit the scope of the claims herein. The person skilled in the art will recognize many variations, alternatives, and modifications of embodiments of the present disclosure. In an example, there could be applied an image lighting-change operation, when a user wants to enter into a darker virtual room or a brighter virtual room in a same physical space.

Referring to FIGS. 4A, 4B, 4C, 4D, and 4E, illustrated are different example implementations of tracking means 400, in accordance with an embodiment of the present disclosure. With reference to FIG. 4A, the tracking means 400 is shown to be implemented as a self-tracking means having a camera thread interface. With reference to FIG. 4B, the tracking means 400 is shown to be implemented as a fixed-mount tracking means. With reference to FIG. 4C, the tracking means 400 is shown to be implemented as a strap-mount tracking means. With reference to FIG. 4D, the tracking means 400 is shown to be implemented as a standardised rail-mount tracking means (for example, a NATO rail-mount tracking means). With reference to FIG. 4E, the tracking means 400 is shown to be implemented as a handle-mount tracking means.

FIGS. 4A-4E are merely examples, which should not unduly limit the scope of the claims herein. The person skilled in the art will recognize many variations, alternatives, and modifications of embodiments of the present disclosure.

1. A method incorporating spatially-defined video-see-through (VST) modifications, wherein the method comprises:
receiving a plurality of VST images of a real-world environment captured using at least one VST camera and depth data captured corresponding to the plurality of VST images, the depth data comprising optical depth values of pixels of each of the plurality of VST images;
receiving a pose of at least one object present in the real-world environment;
analysing the plurality of VST images, the depth data, and the pose of the at least one object, for identifying, in a given VST image, at least one change in at least one spatial volume surrounding the at least one object;
determining a range of optical depth values for each pixel of the given VST image, by projecting the at least one spatial volume onto image coordinates of the given VST image;
determining whether an optical depth value of a given pixel of the given VST image lies within the range of optical depth values determined for said pixel of the given VST image; and
applying at least one image processing operation on the given pixel of the VST image, when it is determined that the optical depth value of the given pixel of the given VST image lies within the range of optical depth values.

2. The method of claim 1, wherein the at least one image processing operation is at least one of: an image colour-change operation, an image lighting-change operation, an image resizing operation, an image rotating operation, an object removal operation, an object occlusion operation, a virtual object generation operation, a geometrical distortion operation, an image blurring operation, an image sharpening operation, a night vision simulation operation, a denoising operation, a noise addition operation.

3. The method of claim 1, wherein the at least one object (302, 304, 308, 310, 312) is at least one of: an interaction device associated with a display apparatus (202), a body part of a user of the display apparatus, at least one another display apparatus, an interaction device associated with the at least one another display apparatus, a body part of a user of the at least one another display apparatus, a person, an animal, a moving object, a static object.

4. The method of claim 1, further comprising processing pose-tracking data, collected by at least one tracking means, to determine the pose of the at least one object, wherein the at least one tracking means is arranged on the at least one object.

5. The method of claim 1, wherein the at least one change in the at least one spatial volume is at least one of:
(i) a change in at least one of: a position, an orientation, a geometry, a state, of the at least one object,
(ii) at least a partial occlusion of the at least one object.

6. The method of claim 1, wherein a size of the at least one spatial volume is predefined, and the size of the at least one spatial volume depends on at least one of: a type of the at least one object, a size of the at least one object, an extent of a tracking of the at least one object.

7. The method of claim 1, wherein a size of the at least one spatial volume is user-configurable.

8. The method of claim 1, wherein the step of analysing the plurality of VST images, the depth data, and the pose of the at least one object comprises:
identifying positions of features of a given object represented in a given VST image; and
refining the positions of the features of the given object by utilising at least one object segmentation technique and the depth data together.

9. The method of claim 1, further comprising applying the at least one image processing operation, based on a predefined criterion in a mixed-reality (MR) environment to be presented to a user via a display apparatus.

10. The method of claim 4, wherein the at least one tracking means is implemented as any one of: a self-tracking means having a camera thread interface, a fixed-mount tracking means, a strap-mount tracking means, a handle-mount tracking means.

11. A system incorporating spatially-defined video-see-through (VST) modifications, wherein the system comprises:
a display apparatus comprising at least one VST camera per eye, the at least one VST camera facing a real-world environment where a user of the display apparatus is present;
at least one tracking means arranged on at least one object present in the real-world environment; and
at least one processor configured to:
receive a plurality of VST images of a real-world environment captured using the at least one VST camera and depth data captured corresponding to the plurality of VST images, the depth data comprising optical depth values of pixels of each of the plurality of VST images;
obtain a pose of the at least one object present in the real-world environment, by processing pose-tracking data that is collected by the at least one tracking means;
analyse the plurality of VST images, the depth data, and the pose of the at least one object, for identifying, in a given VST image, at least one change in at least one spatial volume surrounding the at least one object;
determine a range of optical depth values for each pixel of the given VST image, by projecting the at least one spatial volume onto image coordinates of the given VST image;
determine whether an optical depth value of a given pixel of the given VST image lies within the range of optical depth values determined for said pixel of the given VST image; and
apply at least one image processing operation on the given pixel of the VST image, when it is determined that the optical depth value of the given pixel of the given VST image lies within the range of optical depth values.

12. The system of claim 11, wherein the at least one image processing operation is at least one of: an image colour-change operation, an image lighting-change operation, an image resizing operation, an image rotating operation, an object removal operation, an object occlusion operation, a virtual object generation operation, a geometrical distortion operation, an image blurring operation, an image sharpening operation, a night vision simulation operation, a denoising operation, a noise addition operation.

13. The system of claim 11, wherein the at least one object is at least one of: an interaction device associated with a display apparatus, a body part of a user of the display apparatus, at least one another display apparatus, an interaction device associated with the at least one another display apparatus, a body part of a user of the at least one another display apparatus, a person, an animal, a moving object, a static object.

14. The system of claim 11, wherein the at least one change in the at least one spatial volume is at least one of:
(i) a change in at least one of: a position, an orientation, a geometry, a state, of the at least one object,
(ii) at least a partial occlusion of the at least one object.

15. The system of claim 11, wherein a size of the at least one spatial volume is predefined, and the size of the at least one spatial volume depends on at least one of: a type of the at least one object, a size of the at least one object, an extent of a tracking of the at least one object.
